(19) United States
(12) Patent Application Publication
(10) Pub. No.: US 2021/0342856 A1
(43) Pub. Date: Nov. 4, 2021

(54) CUSTOMER SERVICE ASSISTANCE APPARATUS, CUSTOMER SERVICE ASSISTANCE METHOD, AND COMPUTER-READABLE RECORDING MEDIUM

(71) Applicant: NEC CORPORATION, Tokyo (JP)

(72) Inventors: Junko WATANABE, Tokyo (JP); Hiromi YAMAGUCHI, Tokyo (JP); Shinji NAKADAI, Tokyo (JP)

(73) Assignee: NEC CORPORATION, Tokyo (JP)

(21) Appl. No.: 16/762,023

(22) PCT Filed: Nov. 6, 2018
(86) PCT No.: PCT/JP2018/041086

§ 371 Date: May 6, 2020

(30) Foreign Application Priority Data
Nov. 7, 2017 (JP) 2017-215056

(51) Int. Cl. G06Q 30/00; G06Q 30/02; H04N 7/18; G06F 16/2455

(52) U.S. Cl. CPC G06Q 30/016; G06F 16/24564; H04N 7/18; G06Q 30/0201

(57) ABSTRACT

A customer service assistance apparatus 10 is provided with a video image acquisition unit 11 that acquires a video image of the inside of a store, a specifying unit 12 that specifies a product that a customer in the store is interested in and attributes of the customer based on the acquired video image, an information acquisition unit 13 that acquires information indicating need of the product for the customer, based on the specified product and attributes, and a transmission unit 14 that transmits the acquired content to a terminal apparatus that is used by a store salesperson of the store.

### TECHNICAL FIELD

The present invention relates to a customer service assistance apparatus and a customer service assistance method for assisting a store salesperson in a store in serving a customer, and in particular relates to a computer-readable recording medium in which programs for realizing these are recorded.

### BACKGROUND ART

In recent years, due to developments in IT (Information Technology), various systems for assisting a store salesperson in serving a customer in a retail store have been proposed (for example, see Patent Documents 1 to 3). According to such systems, a store salesperson can efficiently serve a customer compared with a conventional system.

Patent Document 1 discloses a system for transmitting information regarding a customer's taste to a terminal apparatus of a store salesperson. Specifically, when a customer enters a store, the system disclosed in Patent Document 1 specifies the customer based on an image of the customer entering the store, and extracts taste information of the specified customer (for example, attribute information and purchase history of the customer) from a database. The system disclosed in Patent Document 1 then transmits the extracted taste information to a terminal apparatus of a store salesperson, and presents this taste information on the screen of the terminal apparatus. According to the system disclosed in Patent Document 1, the store salesperson can be aware of the customer's tastes, and thus can efficiently serve the customer.

In addition, Patent Document 2 discloses a system for distributing product-related content to a customer's terminal and a store salesperson's terminal. Specifically, the system disclosed in Patent Document 2 transmits content related to a recommended product (a catalog of products, etc.), to a customer's terminal, and transmits a reason for recommending the product to the customer, to a store salesperson's terminal.

For example, assume that the system disclosed in Patent Document 2 has distributed content “XXX bag XXX series of brand XXX” to a customer's terminal. In this case, the system disclosed in Patent Document 2 transmits, to a store salesperson's terminal, a message “XXX is a brand that is highly popular among married ladies in their forties, and is a customer's favorite brand. XXX bag XXX series is a highly popular item. This customer purchases about two bags a year, and it is about time for this customer to purchase a new one”, for example.

When such a message is received by the terminal and is displayed on the screen of the terminal, the store salesperson checks the message. As a result, the store salesperson can confirm a specific reason for recommending the product to the customer, and thus, can efficiently serve the customer in this case as well.

Furthermore, Patent Document 3 discloses a system for analyzing a customer's movement. Specifically, the system disclosed in Patent Document 3 first acquires image information and distance information output from a 3D camera for shooting an image of a product shelf and a customer positioned in front of the product shelf. The system disclosed in Patent Document 3 then specifies a product that is held in a hand of a customer based on the acquired information, and analyzes a customer's movement toward the product based on the ID of the specified product, the position thereof at the point in time (the position of the shelf where the product was located), the time, and the like.

According to information obtained through this analysis, the store can be aware of which shelf and which row in the shelf a product that is frequently touched by customers is located in, and thus can achieve better shelf allocation. In addition, by using this information, the store can specify a change in customers' movement before and after distribution of flyers and before and after an advertisement, and, thus can also understand effects of distribution of flyers and an advertisement. Therefore, also with the use of the system disclosed in Patent Document 3, a store salesperson can efficiently serve a customer.

### LIST OF RELATED ART DOCUMENTS

### Patent Document

Patent Document 1: Japanese Patent Laid-Open Publication No. 2017-004432
Patent Document 2: Japanese Patent Laid-Open Publication No. 2015-219784
Patent Document 3: International Publication WO2015/033577

### SUMMARY OF INVENTION

### Problems to be Solved by the Invention

Incidentally, the most important thing in customer service is to make a customer in a store be “willing to buy”, in other words “motivated to purchase” a product in which the customer is currently showing an interest in actuality. Therefore, there is demand for a system that assists in customer service to suggest, as customer service assistance, what a store salesperson needs to say in order to motivate a customer to purchase a product.

However, the system disclosed in Patent Document 1 only presents information regarding a customer's taste to a store salesperson, and what the store salesperson to which the customer's taste information is presented needs to say to the customer using the taste information is left to the discretion of the store salesperson. In other words, the system disclosed in Patent Document 1 does not suggest what a store salesperson needs to say in order to motivate a customer to purchase a product. Therefore, it is difficult for the system disclosed in Patent Document 1 to sufficiently assist a store salesperson inexperienced in customer service, in particular.

In addition, taste information extracted and presented by the system disclosed in Patent Document 1 is information that is based on a customer's past purchase history. Therefore, if a customer enters a store to purchase a product of a different type from one that the customer has purchased in the past, there is the possibility that a store salesperson will end up saying something inappropriate due to such taste information.

In addition, the system disclosed in Patent Document 2 transmits content related to a recommended product, to a customer's terminal, and transmits a reason for recommending the product to the customer, to a store salesperson's terminal. However, if the customer does not show interest in the recommended product, it is difficult to motivate the customer to purchase the product using the system disclosed in Patent Document 2.

In addition, the system disclosed in Patent Document 3 only has a function of analyzing a customer's movement, and an analyzer needs to determine, based on the analysis result, what a store salesperson should say in order to motivate the customer to purchase a product.

An example object of the invention is to provide a customer service assistance apparatus, a customer service assistance method, and a computer-readable recording medium that make it possible to solve the above problems, and to suggest what a store salesperson needs to say in order to motivate a customer to purchase a product.

### Means for Solving the Problems

In order to achieve the above-described example purpose, a customer service assistance apparatus according to an example aspect of the invention includes:

a video image acquisition unit configured to acquire a video image of the inside of a store;

a specifying unit configured to specify a product that a customer in the store is interested in and an attribute of the customer, based on the acquired video image;

an information acquisition unit configured to acquire information indicating need of the product for the customer, based on the specified product and attribute; and

a transmission unit configured to transmit the acquired information to a terminal apparatus that is used by a store salesperson of the store.

In addition, in order to achieve the above-described example purpose, a customer service assistance method according to an example aspect of the invention includes:

(a) a step of acquiring a video image of the inside of a store;

(b) a step of specifying a product that a customer in the store is interested in and an attribute of the customer, based on the acquired video image;

(c) a step of acquiring information indicating need of the product for the customer, based on the specified product and attribute; and

(d) a step of transmitting the acquired information to a terminal apparatus that is used by a store salesperson of the store.

Furthermore, in order to achieve the above-described example purpose, a computer-readable recording medium according to an example aspect of the invention includes a program recorded thereon, the program including instructions that cause a computer to carry out: (a) a step of acquiring a video image of the inside of a store;

(b) a step of specifying a product that a customer in the store is interested in and an attribute of the customer, based on the acquired video image;

(c) a step of acquiring information indicating need of the product for the customer, based on the specified product and attribute; and

(d) a step of transmitting the acquired information to a terminal apparatus that is used by a store salesperson of the store.

### Advantageous Effects of the Invention

As described above, according to the invention, it is possible to suggest a customer service action that a store salesperson needs to take in order to motivate a customer to purchase a product.

### BRIEF DESCRIPTION OF THE DRAWINGS

FIG. 1 is a block diagram illustrating a schematic configuration of a customer service assistance apparatus according to a first example embodiment of the invention.

FIG. 2 is a block diagram illustrating a configuration of the customer service assistance apparatus according to the first example embodiment of the invention in detail.

FIG. 3 is a layout diagram illustrating an example of layout of a store in which a customer is served according to the first example embodiment of the invention.

FIG. 4 is an explanatory diagram illustrating an example of a state of a store salesperson that is assisted by the customer service assistance apparatus according to the first example embodiment of the invention to serve a customer.

FIG. 5 is a diagram illustrating an example of a rule for deriving customer service information according to the first example embodiment of the present invention.

FIG. 6 is a flowchart illustrating operations of the customer service assistance apparatus according to the first example embodiment of the invention.

FIG. 7 is a block diagram illustrating a configuration of a customer service assistance apparatus according to a second example embodiment of the invention in detail.

FIG. 8 is a diagram illustrating an example of a rule for deriving customer service information according to the second embodiment of the present invention.

FIG. 9 is a flowchart illustrating operations of the customer service assistance apparatus according to the second example embodiment of the invention.

FIG. 10 is a block diagram illustrating an example of a computer that realizes the customer service assistance apparatus according to the first or second example embodiment of the invention.

### EXAMPLE EMBODIMENT

### First Example Embodiment

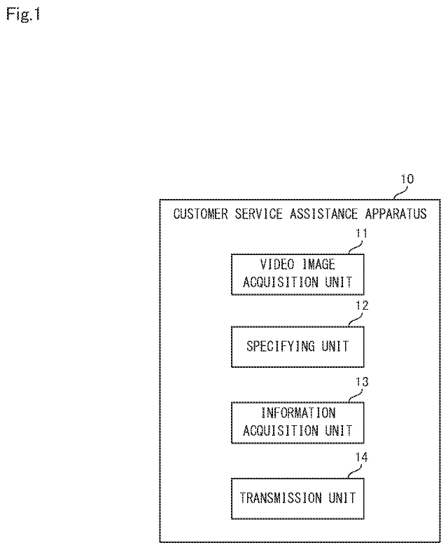

A customer service assistance apparatus, a customer service assistance method, and a program in a first example embodiment of the invention will be described below with reference to FIGS. 1 to 6.

[Apparatus Configuration]

First, a schematic configuration of the customer service assistance apparatus in this first example embodiment will be described with reference to FIG. 1. FIG. 1 is a block diagram illustrating a schematic configuration of the customer service assistance apparatus in the first example embodiment of the invention.

A customer service assistance apparatus 10 according to this first example embodiment illustrated in FIG. 1 is an apparatus for assisting a store salesperson in serving a customer in a store. As illustrated in FIG. 1, the customer service assistance apparatus 10 according to this first example embodiment is provided with a video image acquisition unit 11, a specifying unit 12, an information acquisition unit 13, and a transmission unit 14.

The video image acquisition unit 11 acquires a video image of the inside of a store. The specifying unit 12 specifies a product that a customer in the store is interested in and attributes of the customer, based on the video image acquired by the video image acquisition unit 11. The information acquisition unit 13 acquires information indicating the need of the product for the customer (hereinafter, referred to as “customer service information”) based on the product and attributes specified by the specifying unit 12. The transmission unit 14 transmits the customer service information acquired by the information acquisition unit 13, to a terminal apparatus that is used by a store salesperson of the store.

As described above, in this first example embodiment, when an image of a customer that is interested in a certain product is shot, customer service information is transmitted to a terminal apparatus of a store salesperson. The customer service information includes a reason for recommending the product to the customer, for example. Therefore, the store salesperson can make an appropriate sales pitch in order to motivate the customer to purchase the product. In other words, according to the customer service assistance apparatus 10 in this first example embodiment, what the store salesperson needs to say in order to motivate the customer to purchase the product is suggested.

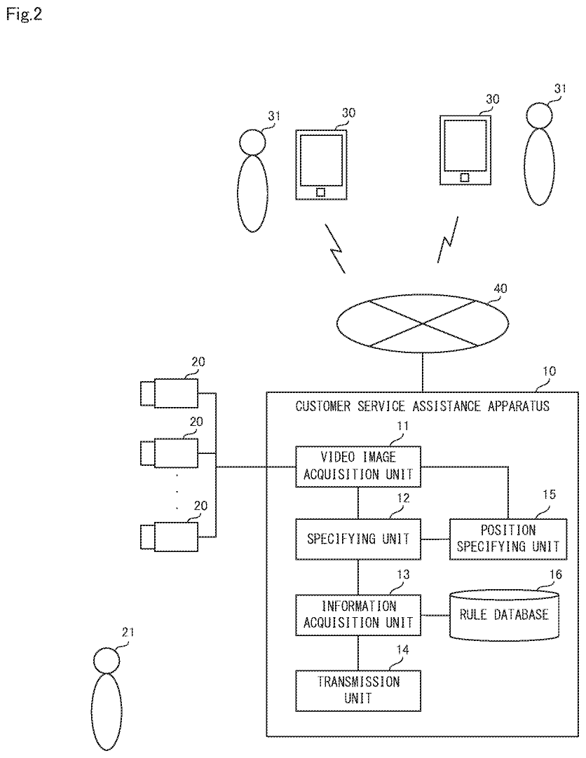

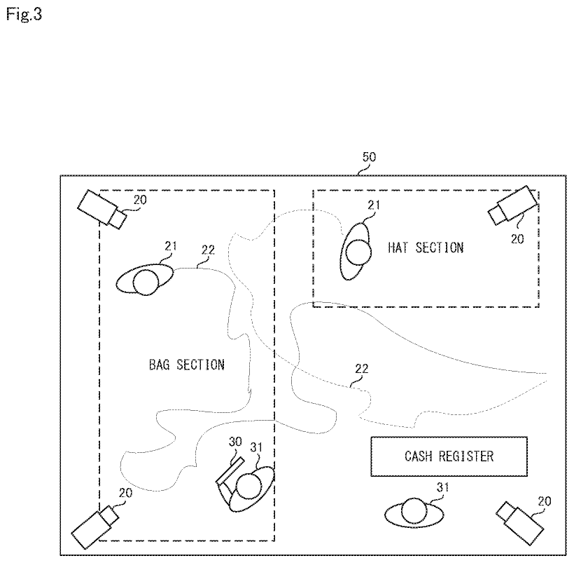

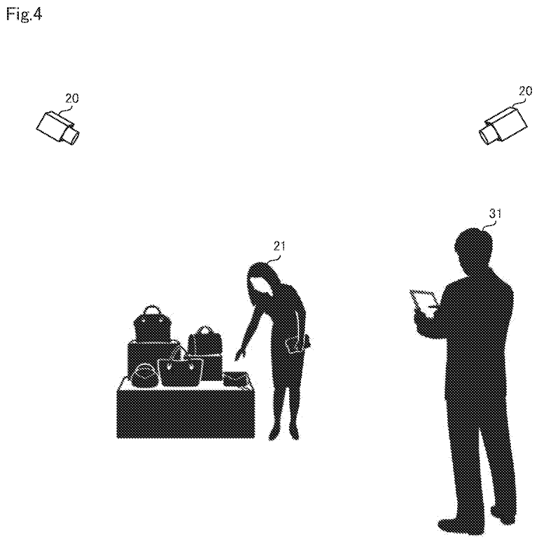

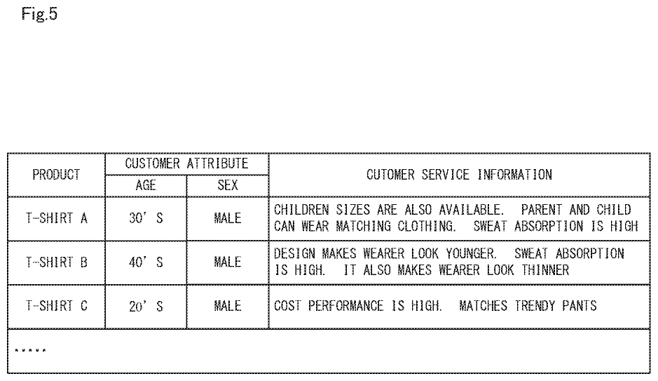

Next, the configuration of the customer service assistance apparatus 10 according to this first example embodiment will be described in more detail with reference to FIGS. 2 to 5. FIG. 2 is a block diagram illustrating the configuration of the customer service assistance apparatus according to the first example embodiment of the invention in detail. FIG. 3 is a layout diagram illustrating an example of the layout of a store in which a customer is served according to the first example embodiment of the invention. FIG. 4 is an explanatory diagram illustrating an example of a state of a store salesperson that is assisted by the customer service assistance apparatus according to the first example embodiment of the invention in serving a customer. FIG. 5 is a diagram illustrating an example of a rule for deriving customer service information according to the first example embodiment of the present invention.

First, as illustrated in FIGS. 2 to 4, a plurality of cameras 20 are installed inside a store 50. Each of the cameras 20 shoots an image of a corresponding region in the store 50, and outputs video image data of the shot region.

In addition, as illustrated in FIG. 2, in this first example embodiment, the customer service assistance apparatus 10 is connected to the plurality of cameras 20, and the video image acquisition unit 11 acquires video image data output from each of the plurality of cameras 20. In addition, the customer service assistance apparatus 10 is connected to a terminal apparatus 30 that is used by a store salesperson 31 of the store 50 via a network 40, to enable data communication.

Furthermore, as illustrated in FIG. 2, in this first example embodiment, the customer service assistance apparatus 10 is also provided with a position specifying unit 15 and a rule database 16 in addition to the video image acquisition unit 11, the specifying unit 12, the information acquisition unit 13, and the transmission unit 14 that have been described above.

The position specifying unit 15 from among the above units first acquires, from the terminal apparatus 30 that is used by the store salesperson 31 of the store 50, positional information for specifying the position of the terminal apparatus 30, and specifies the position of the store salesperson 31 based on the acquired positional information. Moreover, the position specifying unit 15 specifies the position of a customer 21 based on a video image acquired by the video image acquisition unit 11. The position specifying unit 15 then notifies the specifying unit 12 of the specified positions of the store salesperson 31 and the customer 21.

Specifically, if provided with a GPS receiver, the terminal apparatus 30 creates positional information based on a received GPS signal. Also, if connected to the wireless LAN of the store 50, the terminal apparatus 30 creates positional information based on the position of an access point of the wireless LAN to which the terminal apparatus 30 is connected. The position specifying unit 15 acquires positional information created in this manner, from the terminal apparatus 30, and specifies the position of the store salesperson 31 that holds this terminal apparatus 30.

In addition, when a customer 21 appears in video image data acquired by one of the cameras 20, the position specifying unit 15 extracts feature amounts of the customer 21, and tracks the customer 21 based on the extracted feature amounts. At this time, when the customer 21 moves out of frame from video image data of one camera, the position specifying unit 15 detects the feature amounts from video image data of another camera, and continues to track the customer 21. The position specifying unit 15 then specifies the position of the customer 21 in the store 50 that is being tracked, based on installation positions and shooting directions of cameras registered in advance, and the position of the customer 21 in the screen. Also, the position specifying unit 15 can also create flow line information for specifying a moving path 22 of the customer 21 by recording specified positions of the customer 21 in time series as illustrated in FIG. 3.

In addition, in this embodiment, the position specifying unit 15 can also specify the position of the store salesperson 31 based on video image data acquired by a camera 20, similarly to the position of a customer. Specifically, the position specifying unit 15 detects and tracks the store salesperson 31 by comparing feature amounts extracted from video image data with feature amounts indicating the store salesperson 31, which are prepared in advance. The position specifying unit 15 then specifies the position of the store salesperson 31 in the store 50 that is being tracked, based on installation positions and shooting directions of cameras registered in advance, and the position of the store salesperson 31 on the screen.

In addition, in this first example embodiment, if the relationship between the position of the customer 21 and the position of the store salesperson 31 satisfies a set condition, the specifying unit 12 specifies a product that the customer 21 is interested in and the attributes of the customer 21. Examples of the set condition include the distance between the customer 21 and the store salesperson 31 being shorter than or equal to a threshold. In addition, if the above-mentioned flow line information is created, the specifying unit 12 measures, using the flow line information, the number of times the customer 21 has approached the store salesperson 31 by a certain distance, and can also specify a product that the customer 21 is interested in and the attributes of the customer 21, using, as a set condition, the measured number of times being larger than or equal to a threshold.

In addition, in this first example embodiment, the specifying unit 12 specifies a product that the customer 21 is interested in, by using an existing image processing technique. Specifically, the specifying unit 12 first detects an image of the face or a hand of the customer 21 based on video image data, and further detects, based on the detected image, an image of a product to which the face is directed, or an image of a product that is in contact with the hand. The specifying unit 12 then compares feature amounts of the detected image with feature amounts registered for each product in advance, and specifies the product that the customer 21 is interested in.

Furthermore, the specifying unit 12 can also specify the attributes of the customer 21 appearing in a video image, such as their age and sex by using an existing image processing technique. Specifically, the specifying unit 12 extracts feature amounts of the customer 21, and then compares the extracted feature amounts with feature amounts registered for the respective attributes in advance so as to specify the attributes of the customer 21.

In this first example embodiment, the information acquisition unit 13 matches the specified product and attributes with a rule that has been set in advance, and thereby acquires corresponding customer service information. The rule database 16 stores rules for acquiring this customer service information.

Specifically, in this first example embodiment, as illustrated in FIG. 5, the rule database 16 stores a table in which a combination of a product and attributes of the customer 21 corresponds to each of a plurality of pieces of customer service information, and is registered as a rule. For example, assuming that the specifying unit 12 has specified the product as being a T-shirt A and the attributes as being a male in his thirties, the information acquisition unit 13 acquires customer service information “Children sizes are also available. Parent and child can wear matching clothing. Sweat absorption is high.”.

The information acquisition unit 13 then transmits the acquired customer service information to the transmission unit 14. The transmission unit 14 transmits the received customer service information to the terminal apparatus 30 of the store salesperson 31. Accordingly, as illustrated in FIG. 4, the store salesperson 31 can check the customer service information on the screen of the terminal apparatus 30. The store salesperson 31 serves the customer 21 using the displayed customer service information.

[Apparatus Operations]

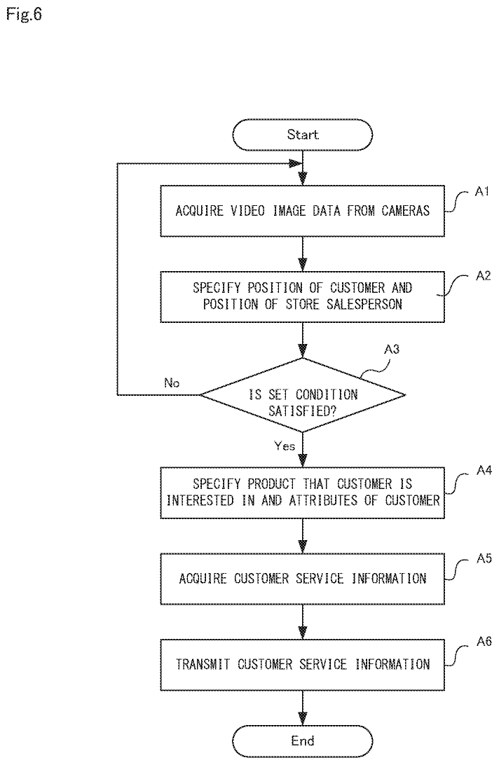

Next, operations of the customer service assistance apparatus 10 according to this first example embodiment will be described with reference to FIG. 6. FIG. 6 is a flowchart illustrating operations of the customer service assistance apparatus according to the first example embodiment of the invention. In the following description, FIGS. 1 to 5 will be referred to as appropriate. In addition, in this first example embodiment, a customer service assistance method is implemented by causing the customer service assistance apparatus 10 to operate. Therefore, description of the customer service assistance method according to this first example embodiment is replaced with the following description of operations of the customer service assistance apparatus 10.

As illustrated in FIG. 6, first, the video image acquisition unit 11 acquires a video image from each of the cameras 20 (step A1). Specifically, in step A1, the video image acquisition unit 11 acquires frames that make up video image data, from each of the cameras 20. The number of frames that are acquired at this time may be one, or two or more.

Next, the position specifying unit 15 specifies the position of the customer 21 and the position of the store salesperson 31 in the store 50 (step A2). Specifically, in step A2, the position specifying unit 15 specifies the position of the store salesperson 31 based on positional information acquired from the terminal apparatus 30. Also, the position specifying unit 15 specifies the position of the customer 21 based on the video image acquired in step A1.

Next, the specifying unit 12 determines whether or not the relationship between the position of the customer 21 and the position of the store salesperson 31 specified in step A2 satisfies a set condition (step A3). Specifically, in step A3, the specifying unit 12 determines whether or not the distance between the customer 21 and the store salesperson 31 is shorter than or equal to a threshold, for example.

As a result of the determination in step A3, if the set condition is not satisfied, step A1 is executed again by the video image acquisition unit 11. On the other hand, as a result of the determination in step A3, if the set condition is satisfied, the specifying unit 12 specifies a product that the customer 21 located in the store 50 is interested in and attributes of the customer 21 (step A4).

Specifically, in step A4, the specifying unit 12 detects an image of the face or a hand of the customer 21 in the video image data, and further detects an image of the product that the customer 21 is interested in, based on the detected image. The specifying unit 12 then compares feature amounts of the detected image with feature amounts registered for each product in advance, and specifies the product that the customer 21 is interested in. In addition, the specifying unit 12 extracts feature amounts of the customer 21, and then compares the extracted feature amounts with feature amounts registered for respective attributes in advance, and specifies the attributes of the customer 21.

Next, the information acquisition unit 13 matches the product and attributes specified in step A4 with a rule registered in the rule database 16 (see FIG. 5), and acquires customer service information corresponding to them (step A5).

Next, the transmission unit 14 transmits the customer service information acquired in step A5, to the terminal apparatus 30 of the store salesperson 31 (step A6). Accordingly, as illustrated in FIG. 4, the store salesperson 31 can check the customer service information on the screen of the terminal apparatus 30.

### Effects of First Example Embodiment

As described above, according to this first example embodiment, since the store salesperson 31 can check customer service information on the screen of the terminal apparatus 30, the store salesperson 31 can easily motivate a customer to purchase a product, and, in particular, can help a customer that cannot decide whether or not to purchase a product that the customer is interested in, to make up their mind. In addition, the customer service information is automatically transmitted to the terminal apparatus 30 of the store salesperson 31 according to the positional relation between the store salesperson 31 and the customer 21, and thus the store salesperson 31 can efficiently serve the customer.

### Modified Example

In the above-described example, if the relationship between the position of the customer 21 and the position of the store salesperson 31 satisfies a set condition, the specifying unit 12 specifies a product that the customer 21 is interested in and attributes of the customer 21, but this first example embodiment is not limited to this example. For example, even if the customer 21 and the store salesperson 31 are distanced from each other, the specifying unit 12 can specify a product that the customer 21 is interested in and attributes of the customer 21.

In this case, the information acquisition unit 13 acquires customer service information based on the specified product and attributes, and also acquires information for specifying the position of the customer. Also, the information acquisition unit 13 creates a message for instructing the store salesperson 31 to approach the customer 21 located at a position distanced therefrom, based on the acquired information, and transmits this message to the transmission unit 14. Accordingly, the transmission unit 14 transmits the message to the terminal apparatus 30 of the store salesperson 31 such that the message is displayed on the screen of the terminal apparatus 30.

Examples of the message include “A female customer in her forties interested in AAA bag BB series of XX brand is in front of so-and-so section (identified by a display shelf number, for example) in the store. Please go and serve the customer”. According to the above aspect, the store salesperson 31 can serve the customer even more efficiently. In addition, such an aspect is particularly useful when there are only a small number of customers 21 in a large store, and the store salesperson 31 has not noticed the customer 21.

[Program]

A program in this first example embodiment may be any program that causes a computer to execute steps A1 to A6 illustrated in FIG. 6. By installing this program in a computer, and executing this program, the customer service assistance apparatus 10 and the customer service assistance method in this first example embodiment can be realized. In this case, a processor of the computer functions as the video image acquisition unit 11, the specifying unit 12, the information acquisition unit 13, the transmission unit 14, and the position specifying unit 15, and performs processing. In addition, in this first example embodiment, the rule database 16 can be realized by storing data files constituting this database to a storage device such as a hard disk provided in a computer.

In addition, the program in this first example embodiment may be executed by a computer system constituted by a plurality of computers. In this case, for example, each of the computers may function as one of the video image acquisition unit 11, the specifying unit 12, the information acquisition unit 13, the transmission unit 14, and the position specifying unit 15. In addition, the rule database 16 may also be built on a computer other than a computer that executes the program according to this first example embodiment.

### Second Example Embodiment

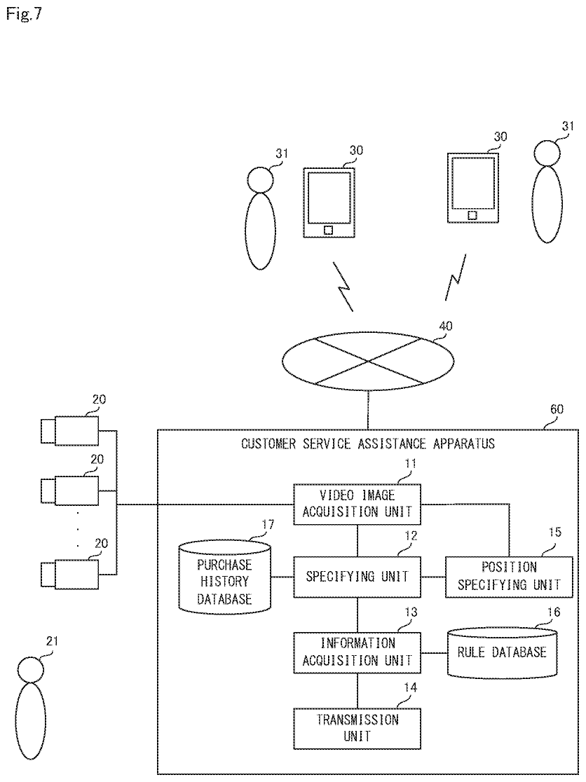

Next, a customer service assistance apparatus, a customer service assistance method, and a program according to a second example embodiment of the invention will be described with reference to FIGS. 7 to 9.

[Apparatus Configuration]

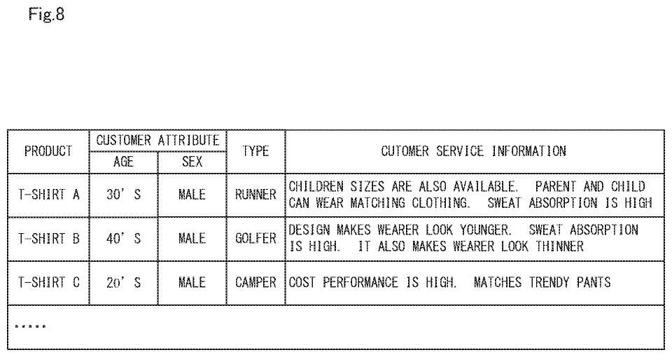

First, a configuration of the customer service assistance apparatus according to this second example embodiment will be described with reference to FIGS. 7 and 8. FIG. 7 is a block diagram illustrating the configuration of the customer service assistance apparatus according to the second example embodiment of the invention in detail. FIG. 8 is a diagram illustrating an example of a rule for deriving customer service information according to the second example embodiment of the present invention.

As illustrated in FIG. 7, a customer service assistance apparatus 60 according to this second example embodiment is different from the customer service assistance apparatus 10 according to the first example embodiment with regard to functions of the specifying unit 12 and the information acquisition unit 13. The differences will be mainly described below.

As illustrated in FIG. 7, in this second example embodiment, the customer service assistance apparatus 60 is provided with a purchase history database 17 in addition to the video image acquisition unit 11, the specifying unit 12, the information acquisition unit 13, the transmission unit 14, the position specifying unit 15, and the rule database 16 described in the first example embodiment. The purchase history database 17 stores identification information of the customer 21 and the past purchase history of the customer 21 in association with each other. Note that a purchase history, which is customer's personal information, is used only when permitted by the customer 21.

In addition, in this second example embodiment, the specifying unit 12 specifies a product that the customer 21 is interested in and attributes of the customer 21 similarly to the first example embodiment, further specifies the past purchase history of the customer based on the purchase history database 17, and also specifies a type indicating a customer's taste based on the specified purchase history.

Specifically, the specifying unit 12 first specifies identification information of the customer 21 based on a video image, and acquires purchase history associated with the specified identification information. For example, assume that the store 50 is a sporting-goods store, and the purchase history is purchase history of sporting-goods. In this case, the specifying unit 12 selects a type that matches the customer 21 from among types that have been set in advance, such as “runner”, “golfer”, “camper”, “swimmer”, and “skier”, based on the acquired purchase history.

In this second example embodiment, the information acquisition unit 13 matches a type with a rule registered in the rule database 16, in addition to the product and attributes, and thereby acquires corresponding customer service information.

Specifically, in this second example embodiment, as shown in FIG. 8, the rule database 16 stores a table in which a combination of a product and attributes and a type of the customer 21 corresponds to each of a plurality of pieces of customer service information, and is registered as a rule. For example, assuming that the specifying unit 12 has specified the product as being a T-shirt B, the attributes as being a male in his forties, and the type as being a golfer, the information acquisition unit 13 acquires customer service information “The design makes the wearer look younger. Sweat absorption is high. It also makes the wearer look thinner”.

[Apparatus Operations]

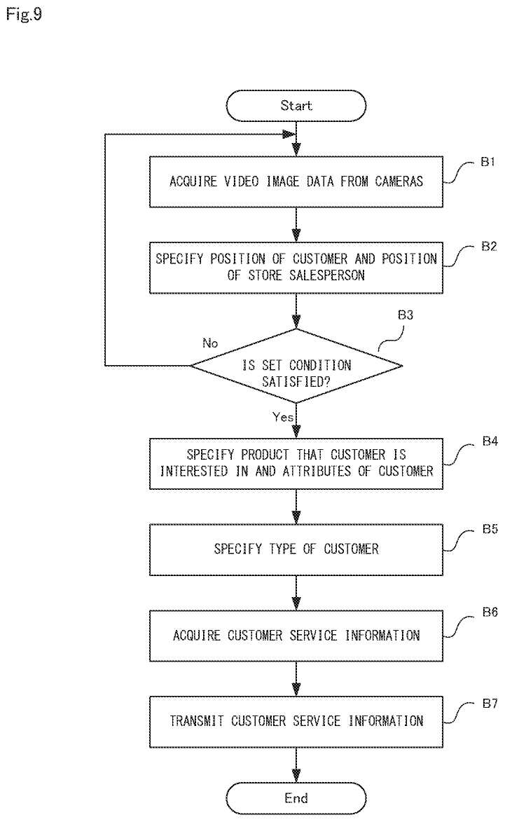

Next, operations of the customer service assistance apparatus 60 according to this second example embodiment will be described with reference to FIG. 9. FIG. 9 is a flowchart illustrating operations of the customer service assistance apparatus according to the second example embodiment of the invention. In the following description, FIGS. 6 to 8 will be referred to as appropriate. In addition, in this second example embodiment, the customer service assistance method is implemented by causing the customer service assistance apparatus 60 to operate. Therefore, description of the customer service assistance method according to this second example embodiment is replaced with the following description of operations of the customer service assistance apparatus 60.

As illustrated in FIG. 9, first, the video image acquisition unit 11 acquires a video image from each of the cameras 20 (step B1). Step B1 is similar to step A1 illustrated in FIG. 6.

Next, the position specifying unit 15 specifies the position of the customer 21 and the position of the store salesperson 31 that are located inside the store 50 (step B2). Step B2 is similar to step A2 illustrated in FIG. 6.

Next, the specifying unit 12 determines whether or not the relationship between the position of the customer 21 and the position of the store salesperson 31 specified in step A2 satisfies a set condition (step B3). Step B3 is similar to step A3 illustrated in FIG. 6.

As a result of the determination in step B3, if the set condition is not satisfied, step B1 is executed again by the video image acquisition unit 11. On the other hand, as a result of the determination of step B3, if the set condition is satisfied, the specifying unit 12 specifies a product that the customer 21 located in the store 50 is interested in and attributes of the customer 21 (step B4). Step B4 is similar to step A4 illustrated in FIG. 6.

Next, the specifying unit 12 further specifies a past purchase history of the customer from the purchase history database 17, and specifies a type indicating a customer's taste based on the specified purchase history (step B5). Specifically, in step B5, the specifying unit 12 selects a type that matches the customer 21 from among types that have been set in advance, based on the purchase history.

Next, the information acquisition unit 13 matches the product and attributes specified in step B4 and the type specified in step B5 with a rule registered in the rule database 16 (see FIG. 8), and acquires customer service information corresponding to these pieces of information (step B6).

Next, the transmission unit 14 transmits the customer service information acquired in step B6 to the terminal apparatus 30 of the store salesperson 31 (step B7). Accordingly, in this second example embodiment as well, as illustrated in FIG. 4, the store salesperson 31 can check the customer service information on the screen of the terminal apparatus 30.

### Effects of Second Example Embodiment

As described above, also in this second example embodiment, similarly to the first example embodiment, the store salesperson 31 can confirm customer service information on the screen of the terminal apparatus 30, and thus can easily motivate the customer to purchase a product, and, particularly can help a customer that cannot decide whether or not to purchase a product that the customer is interested in to make up their mind. In addition, in this second example embodiment, customer service information is specified also in consideration of the type of the customer, and thus it is possible to more reliably help the customer to make up their mind. Moreover, also in this second example embodiment, customer service information is automatically transmitted to the terminal apparatus 30 of the store salesperson 31 according to the positional relation between the store salesperson 31 and the customer 21, and thus the store salesperson can efficiently serve the customer.

[Program]

A program according to this second example embodiment may be any program that causes a computer to execute steps B1 to B7 illustrated in FIG. 9. The customer service assistance apparatus 60 and the customer service assistance method according to this second example embodiment can be realized by installing this program to a computer, and executing the program. In this case, a processor of the computer functions as the video image acquisition unit 11, the specifying unit 12, the information acquisition unit 13, the transmission unit 14, and the position specifying unit 15, and performs processing. In addition, in this second example embodiment, each of the rule database 16 and the purchase history database 17 can be realized by storing data files that constitute the database to a storage device such as a hard disk provided in a computer.

In addition, the program according to this second example embodiment may also be executed by a computer system constituted by a plurality of computers. In this case, for example, each of the computers may function as one of the video image acquisition unit 11, the specifying unit 12, the information acquisition unit 13, the transmission unit 14, and the position specifying unit 15. In addition, the rule database 16 and the purchase history database 17 may also be built on a computer other than a computer that executes the program according to this second example embodiment.

(Physical Configuration)

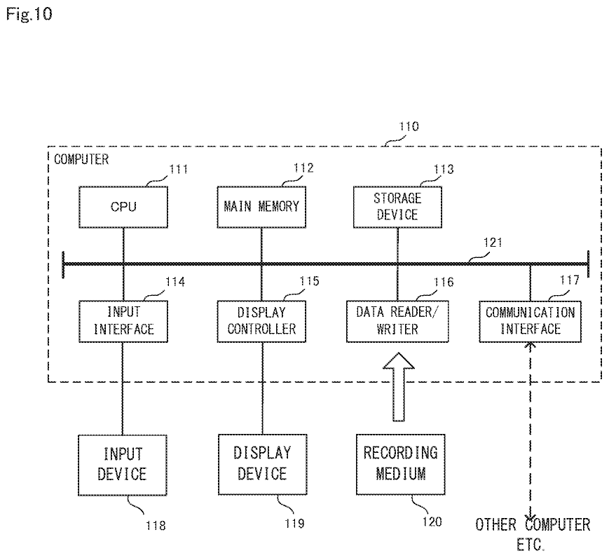

Here, a computer that realizes the customer service assistance apparatus by executing the programs in the first and second example embodiments will be described with reference to FIG. 10. FIG. 10 is a block diagram illustrating an example of a computer that realizes the customer service assistance apparatuses in the first and second example embodiments of the invention.

As illustrated in FIG. 10, a computer 110 is provided with a CPU (Central Processing Unit) 111, a main memory 112, a storage device 113, an input interface 114, a display controller 115, a data reader/writer 116, and a communication interface 117. These units are connected via a bus 121 to enable mutual data communication. Note that the computer 110 may also be provided with a GPU (Graphics Processing Unit) or an FPGA (Field-Programmable Gate Array) in addition to the CPU 111, or in place of the CPU 111.

The CPU 111 carries out various calculations by deploying programs (codes) according to the present example embodiment stored in the storage device 113 to the main memory 112, and executing these in a predetermined order. The main memory 112 is typically a volatile storage device such as a DRAM (Dynamic Random Access Memory). In addition, the programs in the present example embodiment are provided in a state of being stored in a computer-readable recording medium 120. Note that the programs in the present example embodiment may also be programs distributed on the Internet connected via the communication interface 117.

In addition, specific examples of the storage device 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119, and controls display on the display device 119.

The data reader/writer 116 mediates data transmission between the CPU 111 and the recording medium 120, reads out a program from the recording medium 120, and writes a processing result from the computer 110 to the recording medium 120. The communication interface 117 mediates data transmission between the CPU 111 and another computer.

In addition, specific examples of the recording medium 120 include general-purpose semiconductor storage devices such as a CF (Compact Flash (registered trademark)) and an SD (Secure Digital), magnetic recording media such as a flexible disk, and optical recording media such as a CD-ROM (Compact Disk Read Only Memory).

Note that the customer service assistance apparatuses according to the first and second example embodiments can also be realized by using hardware items corresponding to the units instead of a computer in which the programs are installed. Furthermore, a configuration may also be adopted in which a portion of the customer service assistance apparatus is realized by a program, and the remaining portion is realized by hardware.

A portion or the entirety of the above example embodiments can be expressed as Supplementary notes 1 to 12 to be described below, but there is no limitation to the following description.

(Supplementary Note 1)

A customer service assistance apparatus comprising:

a video image acquisition unit configured to acquire a video image of the inside of a store;

a specifying unit configured to specify a product that a customer in the store is interested in and an attribute of the customer, based on the acquired video image;

an information acquisition unit configured to acquire information indicating need of the product for the customer, based on the specified product and attribute; and

a transmission unit configured to transmit the acquired information to a terminal apparatus that is used by a store salesperson of the store.

(Supplementary Note 2)

The customer service assistance apparatus according to Supplementary Note 1,

wherein the information acquisition unit acquires the information by matching the specified product and attribute with a rule that has been set in advance.

(Supplementary Note 3)

The customer service assistance apparatus according to Supplementary Note 2,

wherein the specifying unit specifies past purchase history of the customer, and also specifies a type indicating a taste of the customer based on the specified purchase history, and

the information acquisition unit acquires the information by further matching the specified type with the rule.

(Supplementary Note 4)

The customer service assistance apparatus according to any one of Supplementary Notes 1 to 3, further comprising:

a position specifying unit configured to specify a position of the store salesperson of the store based on positional information for specifying a position of a terminal apparatus that is used by the store salesperson, and also specify a position of the customer based on the acquired video image,

wherein, if a relationship between the position of the customer and the position of the store salesperson satisfies a set condition, the specifying unit specifies a product that the customer is interested in and the attribute of the customer.

(Supplementary Note 5)

A customer service assistance method comprising:

(a) a step of acquiring a video image of the inside of a store;

(b) a step of specifying a product that a customer in the store is interested in and an attribute of the customer, based on the acquired video image;

(c) a step of acquiring information indicating need of the product for the customer, based on the specified product and attribute; and

(d) a step of transmitting the acquired information to a terminal apparatus that is used by a store salesperson of the store.

(Supplementary Note 6)

The customer service assistance method according to Supplementary Note 5,

wherein, in the (c) step, the information is acquired by matching the specified product and attribute with a rule that has been set in advance.

(Supplementary Note 7)

The customer service assistance method according to Supplementary Note 6,

wherein, in the (b) step, past purchase history of the customer is specified, and a type indicating a taste of the customer is also specified based on the specified purchase history, and

in the (c) step, the information is acquired by further matching the specified type with the rule.

(Supplementary Note 8)

The customer service assistance method according to any one of Supplementary Notes 5 to 7, further comprising:

(e) a step of specifying a position of the store salesperson of the store based on positional information for specifying a position of a terminal apparatus that is used by the store salesperson, and also specifying a position of the customer based on the acquired video image,

wherein, in the (b) step, if a relationship between the position of the customer and the position of the store salesperson satisfies a set condition, a product that the customer is interested in and the attribute of the customer are specified.

(Supplementary Note 9)

A computer-readable recording medium that includes a program recorded thereon, the program including instructions that cause a computer to carry out:

(a) a step of acquiring a video image of the inside of a store;

(b) a step of specifying a product that a customer in the store is interested in and an attribute of the customer, based on the acquired video image;

(c) a step of acquiring information indicating need of the product for the customer, based on the specified product and attribute; and

(d) a step of transmitting the acquired information to a terminal apparatus that is used by a store salesperson of the store.

(Supplementary Note 10)

The computer-readable recording medium according to Supplementary Note 9,

wherein, in the (c) step, the information is acquired by matching the specified product and attribute with a rule that has been set in advance.

(Supplementary Note 11)

The computer-readable recording medium according to Supplementary Note 10,

wherein, in the (b) step, past purchase history of the customer is specified, and a type indicating a taste of the customer is also specified based on the specified purchase history, and

in the (c) step, the information is acquired by further matching the specified type with the rule.

(Supplementary Note 12)

The computer-readable recording medium according to any one of Supplementary Notes 9 to 11, the program further including an instruction that causes a computer to carry out:

(e) a step of specifying a position of the store salesperson of the store based on positional information for specifying a position of a terminal apparatus that is used by the store salesperson, and also specifying a position of the customer based on the acquired video image, and,

wherein, in the (b) step, if a relationship between the position of the customer and the position of the store salesperson satisfies a set condition, a product that the customer is interested in and the attribute of the customer are specified.

Although the present invention has been described above with reference to the example embodiments above, the invention is not limited to the above example embodiments. Various modifications understandable to a person skilled in the art can be made in configurations and details of the invention, within the scope of the invention.

This application is based upon and claims the benefit of priority from Japanese Patent Application No. 2017-215056, filed Nov. 7, 2017, the disclosure of which is incorporated herein in its entirety by reference.

### INDUSTRIAL APPLICABILITY

As described above, according to the invention, it is possible to suggest a customer service action that a store salesperson needs to take in order to motivate a customer to purchase a product. The invention is useful to any application in which a store salesperson needs to serve a customer, without particular limitation.

### LIST OF REFERENCE SIGNS

10 Customer service assistance apparatus (first example embodiment)
11 Video image acquisition unit
12 Specifying unit
13 Information acquisition unit
14 Transmission unit
15 Position specifying unit
16 Rule database
17 Purchase history database
20 Camera
21 Customer
22 Moving path
30 Terminal apparatus
31 Salesperson
40 Network
50 Store
60 Customer service assistance apparatus (second example embodiment)
110 Computer
111 CPU
112 Main memory
113 Storage apparatus
114 Input interface
115 Display controller
116 Data reader/writer
117 Communication interface
118 Input device
119 Display device
120 Recording medium
121 Bus

1. A customer service assistance apparatus comprising:
a video image acquisition unit configured to acquire a video image of the inside of a store;
a specifying unit configured to specify a product that a customer in the store is interested in and an attribute of the customer, based on the acquired video image;
an information acquisition unit configured to acquire information indicating need of the product for the customer, based on the specified product and attribute; and
a transmission unit configured to transmit the acquired information to a terminal apparatus that is used by a store salesperson of the store.

2. The customer service assistance apparatus according to claim 1,
wherein the information acquisition unit acquires the information by matching the specified product and attribute with a rule that has been set in advance.

3. The customer service assistance apparatus according to claim 2,
wherein the specifying unit specifies past purchase history of the customer, and also specifies a type indicating a taste of the customer based on the specified purchase history, and
the information acquisition unit acquires the information by further matching the specified type with the rule.

4. The customer service assistance apparatus according claim 1, further comprising:
a position specifying unit configured to specify a position of the store salesperson of the store based on positional information for specifying a position of a terminal apparatus that is used by the store salesperson, and also specify a position of the customer based on the acquired video image,
wherein, if a relationship between the position of the customer and the position of the store salesperson satisfies a set condition, the specifying unit specifies a product that the customer is interested in and the attribute of the customer.

5. A customer service assistance method comprising:
acquiring a video image of the inside of a store;
specifying a product that a customer in the store is interested in and an attribute of the customer, based on the acquired video image;
acquiring information indicating need of the product for the customer, based on the specified product and attribute; and
transmitting the acquired information to a terminal apparatus that is used by a store salesperson of the store.

6. The customer service assistance method according to claim 5,
wherein, in the acquiring information, the information is acquired by matching the specified product and attribute with a rule that has been set in advance.

7. The customer service assistance method according to claim 6,
wherein, in the specifying, past purchase history of the customer is specified, and a type indicating a taste of the customer is also specified based on the specified purchase history, and
in the acquiring information, the information is acquired by further matching the specified type with the rule.

8. The customer service assistance method according to claim 5, further comprising:
specifying a position of the store salesperson of the store based on positional information for specifying a position of a terminal apparatus that is used by the store salesperson, and also specifying a position of the customer based on the acquired video image,
wherein, in the specifying, if a relationship between the position of the customer and the position of the store salesperson satisfies a set condition, a product that the customer is interested in and the attribute of the customer are specified.

9. A non-transitory computer-readable recording medium that includes a program recorded thereon, the program including instructions that cause a computer to carry out:
acquiring a video image of the inside of a store;
specifying a product that a customer in the store is interested in and an attribute of the customer, based on the acquired video image;
acquiring information indicating need of the product for the customer, based on the specified product and attribute; and
transmitting the acquired information to a terminal apparatus that is used by a store salesperson of the store.

10. The non-transitory computer-readable recording medium according to claim 9,
wherein, in the acquiring information, the information is acquired by matching the specified product and attribute with a rule that has been set in advance.

11. The non-transitory computer-readable recording medium according to claim 10,
wherein, in the specifying, past purchase history of the customer is specified, and a type indicating a taste of the customer is also specified based on the specified purchase history, and
in the acquiring information, the information is acquired by further matching the specified type with the rule.

12. The non-transitory computer-readable recording medium according claim 9, the program further including an instruction that causes a computer to carry out:
specifying a position of the store salesperson of the store based on positional information for specifying a position of a terminal apparatus that is used by the store salesperson, and also specifying a position of the customer based on the acquired video image, and,
wherein, in the specifying, if a relationship between the position of the customer and the position of the store salesperson satisfies a set condition, a product that the customer is interested in and the attribute of the customer are specified.
